(19) United States
(12) Patent Application Publication
(10) Pub. No.: US 2014/0081881 A1
(43) Pub. Date: Mar. 20, 2014

(54) SOCIAL NETWORK BASED MAPPING

(71) Applicant: INTERNATIONAL BUSINESS MACHINES CORPORATION, Armonk, NY (US)

(72) Inventor: Rajesh Radhakrishnan, Reston, VA (US)

(73) Assignee: International Business Machines Corporation, Armonk, NY (US)

(21) Appl. No.: 13/621,319

(22) Filed: Sep. 17, 2012

(51) Int. Cl. G06Q 99/00

(52) U.S. Cl. 705/319

(57) ABSTRACT

A method and system for mapping in accordance with social networking data. The method includes receiving data associated with a user. A computer processor periodically retrieves explicit and implicit social networking data associated with the user. The computer processor analyzes the explicit social networking data, the implicit social networking data, and the first data and generates resulting analysis data. The computer processor generates different travel routes from an initial user location to a user specified destination. Each travel route comprises various stopping points associated with locations of individuals related to the user. Graphical images associated with the individual are generated and presented to the user in combination with graphical representations of the different travel routes via a multifaceted display of each travel route.

### FIELD

One or more embodiments of the invention relate generally to a method for highlighting search results, and in particular to a method and associated system for using social networking data for mapping user routes.

### BACKGROUND

Planning user trips includes an inaccurate process with little flexibility. Generating travel scenarios may include a complicated process that may be time consuming and require a large amount of resources. Accordingly, there exists a need in the art to overcome at least some of the deficiencies and limitations described herein above.

### SUMMARY

A first embodiment of the invention provides a method including: receiving, by a computing system including a computer processor, first data associated with a user; periodically retrieving, by the computer processor, explicit social networking data associated with the user; periodically retrieving, by the computer processor, implicit social networking data associated with the user; first analyzing, by the computer processor, the explicit social networking data, the implicit social networking data, and the first data; generating, by the computer processor, analysis data including results of the first analyzing; receiving, by the computer processor, a request for planning a route of travel from a first location to a specified destination; second analyzing, by the computer processor in response to the receiving the request, the analysis data with respect to the first location and the specified destination; generating, by the computer processor in response to results of the second analyzing, a plurality of different travel routes from the first location to the specified destination, wherein each travel route of the plurality of different travel routes includes various stopping points associated with locations of individuals including relationships to the user; generating, by the computer processor, graphical images associated with the individuals, wherein each graphical image of the graphical images includes a differing graphical image based on a type of relationship of the relationships; and presenting, by the computer processor to the user, graphical representations of the plurality of different travel routes, the graphical representations including the graphical images at associated stopping points of the various stopping points.

A second embodiment of the invention provides a computer program product, including a computer readable storage device storing a computer readable program code, the computer readable program code including an algorithm that when executed by a computer processor of a computer system implements a method, the method including: receiving, by the computer processor, first data associated with a user; periodically retrieving, by the computer processor, explicit social networking data associated with the user; periodically retrieving, by the computer processor, implicit social networking data associated with the user; first analyzing, by the computer processor, the explicit social networking data, the implicit social networking data, and the first data; generating, by the computer processor, analysis data including results of the first analyzing; receiving, by the computer processor, a request for planning a route of travel from a first location to a specified destination; second analyzing, by the computer processor in response to the receiving the request, the analysis data with respect to the first location and the specified destination; generating, by the computer processor in response to results of the second analyzing, a plurality of different travel routes from the first location to the specified destination, wherein each travel route of the plurality of different travel routes includes various stopping points associated with locations of individuals including relationships to the user; generating, by the computer processor, graphical images associated with the individuals, wherein each graphical image of the graphical images includes a differing graphical image based on a type of relationship of the relationships; and presenting, by the computer processor to the user, graphical representations of the plurality of different travel routes, the graphical representations including the graphical images at associated stopping points of the various stopping points.

A third embodiment of the invention provides a computer system including a computer processor coupled to a computer-readable memory unit, the memory unit including instructions that when executed by the computer processor implements a method including: receiving, by the computer processor, first data associated with a user; periodically retrieving, by the computer processor, explicit social networking data associated with the user; periodically retrieving, by the computer processor, implicit social networking data associated with the user; first analyzing, by the computer processor, the explicit social networking data, the implicit social networking data, and the first data; generating, by the computer processor, analysis data including results of the first analyzing; receiving, by the computer processor, a request for planning a route of travel from a first location to a specified destination; second analyzing, by the computer processor in response to the receiving the request, the analysis data with respect to the first location and the specified destination; generating, by the computer processor in response to results of the second analyzing, a plurality of different travel routes from the first location to the specified destination, wherein each travel route of the plurality of different travel routes includes various stopping points associated with locations of individuals including relationships to the user; generating, by the computer processor, graphical images associated with the individuals, wherein each graphical image of the graphical images includes a differing graphical image based on a type of relationship of the relationships; and presenting, by the computer processor to the user, graphical representations of the plurality of different travel routes, the graphical representations including the graphical images at associated stopping points of the various stopping points.

### BRIEF DESCRIPTION OF THE DRAWINGS

FIG. 1 illustrates a system for linking a user's social network and associated location data within the social network with online mapping or GPS systems, in accordance with embodiments of the present invention.

FIG. 2 illustrates an algorithm detailing a process flow enabled by the system of FIG. 1, in accordance with embodiments of the present invention.

FIG. 3 illustrates a screen shot, in accordance with embodiments of the present invention.

FIG. 4 illustrates a computer apparatus used by the system of FIG. 1 for linking a user's social network and associated location data within the social network with online mapping or GPS systems, in accordance with embodiments of the present invention.

### DETAILED DESCRIPTION

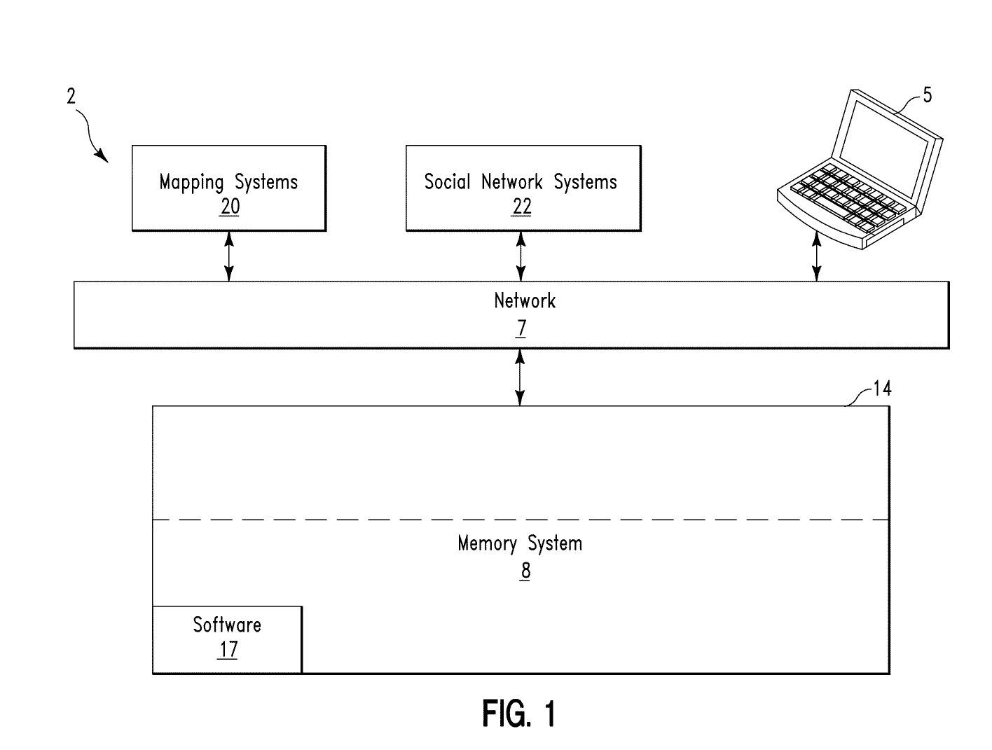

FIG. 1 illustrates a system 2 for linking a user's social network and associated location data (e.g., home address, office address, etc) within the social network with online mapping or GPS systems, in accordance with embodiments of the present invention. The above and other features of the present invention will become more distinct by a detailed description of embodiments shown in combination with attached drawings. Identical reference numbers represent the same or similar parts in the attached drawings of the invention.

As will be appreciated by one skilled in the art, aspects of the present invention can be embodied as a system, method or computer program product. Accordingly, aspects of the present invention can take the form of an entirely hardware embodiment, an entirely software embodiment (including firmware, resident software, micro-code, etc.) or an embodiment combining software and hardware aspects that can all generally be referred to herein as a “circuit,” “module” or “system.” Furthermore, aspects of the present invention can take the form of a computer program product embodied in one or more computer readable medium(s) having computer readable program code embodied thereon.

Any combination of one or more computer readable medium(s) can be utilized. A computer readable storage medium can be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium can include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium can be any tangible medium that can contain, or store a program for use by or in connection with an instruction execution system, apparatus, or device.

Computer program code for carrying out operations for aspects of the present invention can be written in any combination of one or more programming languages, including an object oriented programming language such as Java, Smalltalk, C++ or the like and conventional procedural programming languages, such as the “C” programming language or similar programming languages. The program code can execute entirely on the user's computer, partly on the user's computer, as a stand-alone software package, partly on the user's computer.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions can also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams can represent a module, segment, or portion of code, which includes one or more executable instructions for implementing the specified logical function(s). It should also be noted that, in some alternative implementations, the functions noted in the block can occur out of the order noted in the figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

System 2 generates route mapping results (for a requested route of travel) embedded with graphical images (e.g., icons) representing various locations (e.g., addresses) of friends and family along the route. System 2 generates several routes of travel (from a starting location to a destination). Each route of travel includes a different route based on locations for friends and/or family (retrieved from social networks) of the requesting user. For example, a user is planning to travel from a home location in Virginia to a state park B in the state of N.Y. System 2 generates a primary map route based on a shortest route using national and state highways. Additionally, system 2 generates a secondary map route via a suburb of Corning N.Y. that includes a friend (of the user from a social network A) that lives in the suburb of Corning, N.Y. located within a 10 mile detour from the primary route to the state park B. Additionally, system 2 generates a third map indicating a route via Syracuse, N.Y. The third map indicates that an uncle/aunt live in Syracuse, N.Y. The third map indicates an extended route that will extend the trip by 70 miles. In response, the user may select one of the aforementioned three maps based on a preference to visit the friend or family members.

System 2 of FIG. 1 includes mapping systems 20, social network systems 22, and a computer 5 connected through a network 7 to a computing system 14. Mapping systems 22 may include any type of map generation systems including, inter alia, online mapping systems, GPS mapping systems, etc. Social network systems 22 may include any type of social networks associated with a user including, inter alia, online Website based social networks, etc. Network 7 may include any type of network including, inter alia, a local area network, (LAN), a wide area network (WAN), the Internet, a wireless network, etc. Computer 5 may include any type of computing system(s) including, inter alia, a computer (PC), a laptop computer, a tablet computer, a server, a PDA, a smart phone, etc. Computing system 14 may include any type of computing system(s) including, inter alia, a computer (PC), a laptop computer, a tablet computer, a server, etc. Computing system 14 includes a memory system 8. Memory system 8 may include a single memory system. Alternatively, memory system 8 may include a plurality of memory systems. Memory system 8 includes software 17. Software 17 allows for route search results to display a specific destination address to be displayed in a faceted manner. For example, the search results may be displayed in multiple tabs. A first facet (in a first tab) may display a primary map route based on a shortest route, a second facet (in a second tab) may display a second route that includes locations of interest (for a user) and locations within a 30 mile radius that include locations (e.g., residences and offices) of friends within a social network of the user, and a third facet (in a third tab) may display a third route that includes the locations of interest (for a user) and locations within a 30 mile radius that include locations (e.g., residences and offices) of relatives (of the user) retrieved from the social network of the user. For example, the user may be searching for a hotel chain A. Facet 1 displays the primary map with only locations of the nearest hotels from the hotel chain A. Facet 2 displays the nearest hotels from the hotel chain A and locations of friends (based on social network data) within 30 miles of the nearest hotels from the hotel chain A within a map. The third facet displays both (of the first two) map results and includes locations of relatives (based on social network data) within 30 miles of the nearest hotels from the hotel chain A within a map.

System 2 enables a method to securely apply a user's social network information from social networking online Websites to refine mapping and GPS search results and associate the results with locations that are specifically related to both the user's mapping destination search and locations of friends and or relatives of the user. System 2 generates graphical images (e.g., icons) representing the locations (i.e., locations of friends and or relatives of the user) on the map. The icons may include logos indicating various relationships, first icons indicating immediate relatives, second (differing) icons indicating distant relatives, and third icons indicating friends. System 2 receives periodic updates from social networking Websites in order to accurately generate the various maps and icons.

System 2 enables users to register with a (Web) service that will capture and store individual social network data so that when an online mapping or GPS search is performed for a particular destination, distance, or direction (e.g., from point A to point B, from point A to point B, to point C), the service will extract locations that align with the captured social network data. Additionally, the service searches a user's social network data and displays current locations of individuals associated with the user's social network (e.g., friends and family). Users may tailor results to be displayed as, inter alia, a primary map without any social network data populated, a first map displaying friends (a select few or many) only, a second map displaying relatives, etc. Additionally (for security reasons), the service may only search for and retrieve members of a user's social network that are registered with the service and have allowed the user to capture and present their location (e.g., residence address) information as part of mapping search results. The following implementation example describes a scenario associated with linking a user's social network and associated location data (e.g., home address, office address, etc) within the social network with online mapping or GPS systems:

### EXAMPLE 1

An end user A is planning a trip to a service conference. The end user A enters a conference center address on a Website mapping search application or a GPS location search system (e.g., a Web device or hand held device). In response, multifaceted search results illustrate a map to the conference center (illustrated with a primary icon such as location A) and close friends (as defined by the social network data and data analysis) of the user within a radius of 10 miles from the route. The multifaceted search results additionally illustrate a map to the conference center and close relatives (as defined by the social network data and data analysis) of the user within a radius of 10 miles from the route. Therefore, system 2 allows users to pin point an exact location of friends or relatives and optimize travel plans based on a distance to each of the friends and/or relatives locations so that they may coordinate travel plans with the friends and/or relatives.

System 2 provides a Web-based application programming interface (API) to download user preferences from input sources (e.g., social networking Websites, search engines, etc). Social networking Websites provide general and location based preferences of a user and an associated circle of family/friends. Search engines provide relevant results from the user's search history. The following description describes a process for linking user's social network and associated location data (e.g., home address, office address, etc) within the social network with online mapping or GPS systems:

The Web-based API accepts user profile and location information (e.g., User=David W., Destination address=New York, Current address=Washington, D.C.). An on-demand invocation to the API (provided by social networking Websites) retrieves the user profile, friends and relative data, and location information as inputs and generates an output including a complex structure representing general user preferences and social network member location. Additionally, the on-demand invocation to the API (provided by the social networking Websites) retrieves the user profile and location information of members of the social network as an input and generates (as an output) a complex structure representing general and location information associated with subscribed members in the user's social network. Additional filters to restrict (e.g., a selected subset of members) this data may are applied to the outputs. As a third input, the on-demand invocation to the API (provided by the search engines) retrieves the user profile and location information as an input and generates an output including a complex structure representing a general user profile and location of the user's social network members. A smart analytics engine (e.g., of software 17) process results received from input sources and filters out irrelevant information. The analytics engine includes capabilities such as, inter alia, text analytics, web analytics, a category sorter, an ability to filter locations based on area/radius to display within, etc. System 2 provides an interactive graphical user interface (GUI) for interacting with the analytics engine to display results that are integrated with a location map. The GUI accepts user preferences to illustrate more/less information based on user needs by filtering out categories, specific points, restricted circles (circle of friends or relatives), etc. The implementation of this application/service may take advantage of: web-based SOA frameworks, enterprise bus for inter-process communication, virtual based services for world wide deployment, and universal description discovery and integration technologies to add new social networks and search engines automatically.

System 2 provides the following functionality:
1. Integrating social network data associated with locations (e.g., residential addresses) of friends and relatives (of an end user) with map search results (location search, distance search, direction search results, etc).
2. Mapping Website collection search results associated with social network data for each end user.
3. An end user is logged in with UID/password (or cookies) thereby storing his/her social network data is in a memory system associated with an online or GPS mapping tool.
4. Providing faceted search information (e.g., search results) for map searches involving a direction from point A to point B or multiple destinations (e.g., point A to point B to point C). The faceted search results enable each facet to display maps including different brand locations. As a first example, a first facet may display a first map illustrating close relatives (of an end user) along a road way/direction from point A to point B. As a second example, a second facet may display a second map illustrating close friends (of the end user) along the road way/direction from point A to point B. As a third example, a third facet may display a third map illustrating distant relatives (of the end user) along the road way/direction from point A to point B.

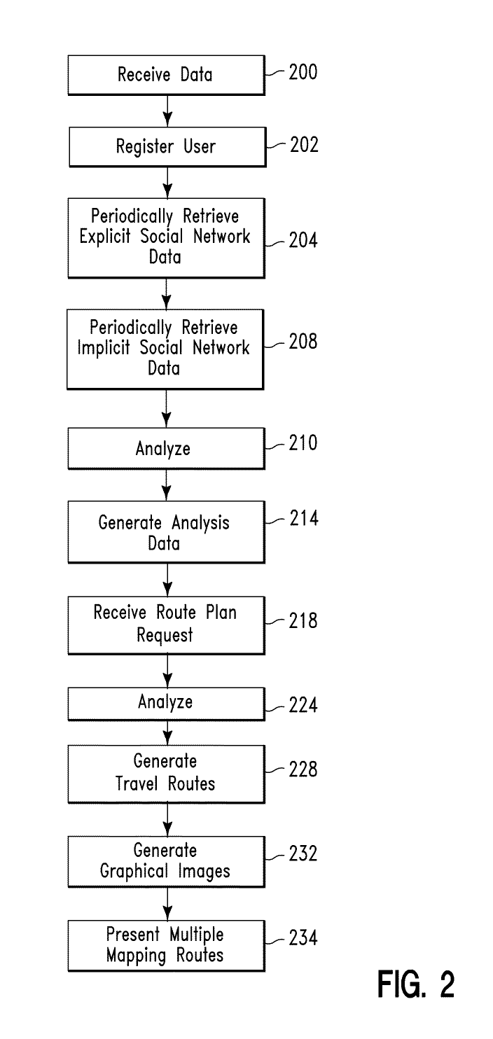

FIG. 2 illustrates an algorithm detailing a process flow enabled by system 2 of FIG. 1 for linking a user's social network and associated location data within the social network with online mapping or GPS systems 22, in accordance with embodiments of the present invention. Each of the steps in the algorithm of FIG. 2 may be enabled and executed by a computer processor executing computer code. In step 200, first data associated with a user is retrieved. The first data may include, inter alia, demographic data, financial institution data, user identity data, data associated with Websites accessed by the user, data associated with services requested by the user, etc. In step 202, the user is registered (based on the first data) with a network mapping service (e.g., a Web based mapping service, a GPS based mapping service, etc). In step 204, explicit social networking data associated with the user is periodically retrieved from associated social networking systems. Explicit social networking data includes social networking data that is explicitly stated by the user via a family tree or friend trees. In step 208, implicit social networking data associated with the user is periodically retrieved from the associated social networking systems. Implicit social networking data includes social networking data that is based on implicit social relationships and strengths of social relationships deciphered via analysis implicitly. For example, implicit social networking data may be based on text analytics applied to messages and communication data within social networks or outside of social networks (e.g., email data) to be used to understand relationships based on frequency and type (invitation, greetings, etc) of communication messages. As a second example, implicit social networking data may be based on an affinity and sentiment analysis to describe relationships and a strength of the relationships based on analysis of social networking and messaging data. In step 210, first the explicit social networking data, the implicit social networking data, and the first data is analyzed. The analysis of step 210 may include:
1. Performing a user profile analysis with respect to the first data, the explicit social networking data, and the implicit social networking data.
2. Performing an entity analysis with respect to the first data, the explicit social networking data, and the implicit social networking data. An entity analysis establishes an identity of friends and relatives of the user's social network
3. Performing an affinity analysis with respect to the first data, the explicit social networking data, and the implicit social networking data. An affinity analysis establishes affinity groups such as, inter alia, university alumni groups, classmates, groups with similar interests (e.g., kayakers, runners, etc) etc to establish relationships and a strength of relationships.
4. Performing a relationship analysis with respect to the first data, the explicit social networking data, and the implicit social networking data.
5. Performing a sentiment analysis with respect to the first data, the explicit social networking data, and the implicit social networking data. A sentiment analysis retrieves sentimental statements (e.g., wishes and greetings, disagreements and animosity, empathy and compassion, etc) to establish a type of relationship and strength of relationships.

In step 214, analysis data including results of the analysis of step 210 is generated. In step 218, a request for planning a route of travel from a first location to a specified destination is received. In step 224, the analysis data is analyzed with respect to the first location and the specified destination. In step 228, a plurality of different travel routes from the first location to the specified destination are generated. Each travel of the travel routes includes various stopping points associated with locations of individuals including relationships (e.g., friends, family, etc) to the user. In step 232, graphical images associated with the individuals are generated. Each graphical image may include a differing graphical image based on a type of relationship to the user. For example, graphical images may include: different geographical shapes, different colors, different fonts, different types of images, etc. In step 234, the graphical representations of the different travel routes including the graphical images at associated stopping points of the various stopping points are presented to the user.

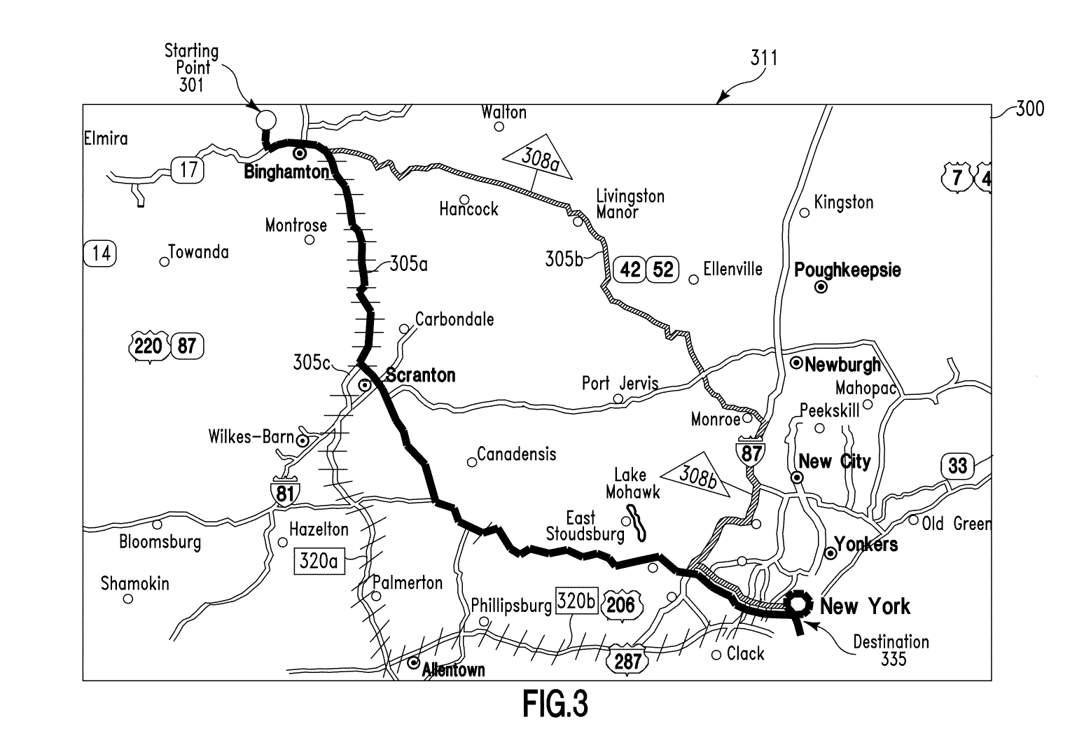

FIG. 3 illustrates a screen shot 300 including an example of a map 311, in accordance with embodiments of the present invention. Map 311 presents multiple different routes of travel 305a, 305b, and 305c from starting point 301 to destination 335. Route of travel 305a includes a primary route from starting point 301 to destination 335 without any stopping points. Route of travel 305b includes a secondary route from starting point 301 to destination 335 including graphical images 308a and 308b representing stopping points for relatives of the user. Route of travel 305c includes another secondary route from starting point 301 to destination 335 including graphical images 320a and 320b representing stopping points for friends of the user. Alternatively, route of travel 305a may be presented on a first discrete map, route of travel 305b may be presented on a second discrete map, and route of travel 305c may be presented on a third discrete map.

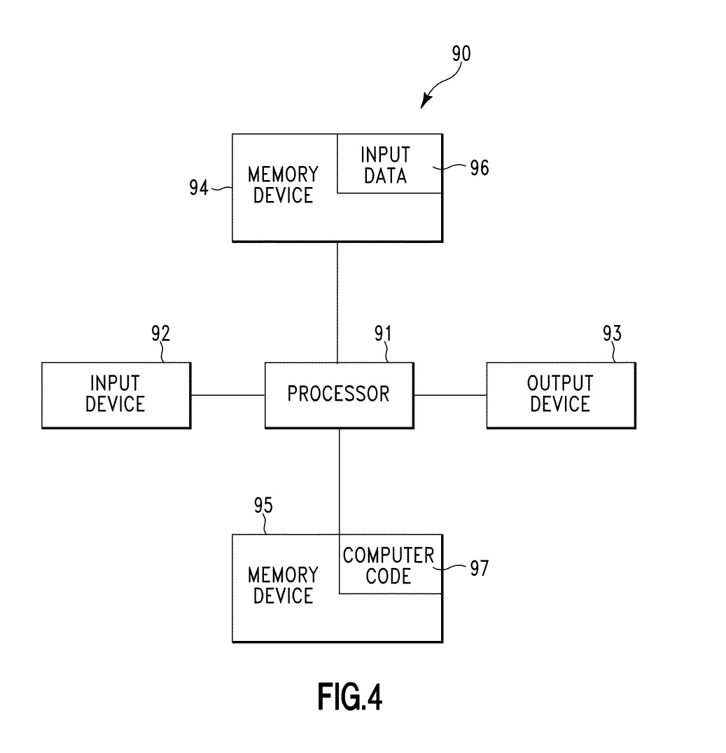

FIG. 4 illustrates a computer apparatus 90 (e.g., computing system 14 of FIG. 1) used by system 2 of FIG. 1 for linking a user's social network and associated location data within the social network with online mapping or GPS systems, in accordance with embodiments of the present invention. The computer system 90 includes a processor 91, an input device 92 coupled to the processor 91, an output device 93 coupled to the processor 91, and memory devices 94 and 95 each coupled to the processor 91. The input device 92 may be, inter alia, a keyboard, a mouse, etc. The output device 93 may be, inter alia, a printer, a plotter, a computer screen, a magnetic tape, a removable hard disk, a floppy disk, etc. The memory devices 94 and 95 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 95 includes a computer code 97. The computer code 97 includes algorithms (e.g., the algorithm of FIG. 2) for linking a user's social network and associated location data within the social network with online mapping or GPS systems. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 4) may include the algorithm of FIG. 2 and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

Still yet, any of the components of the present invention could be created, integrated, hosted, maintained, deployed, managed, serviced, etc. by a service supplier who offers to link a user's social network and associated location data within the social network with online mapping or GPS systems. Thus the present invention discloses a process for deploying, creating, integrating, hosting, maintaining, and/or integrating computing infrastructure, including integrating computer-readable code into the computer system 90, wherein the code in combination with the computer system 90 is capable of performing a method for capturing and managing information requirements. In another embodiment, the invention provides a business method that performs the process steps of the invention on a subscription, advertising, and/or fee basis. That is, a service supplier, such as a Solution Integrator, could offer to link a user's social network and associated location data within the social network with online mapping or GPS systems. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 4 shows the computer system 90 as a particular configuration of hardware and software, any configuration of hardware and software, as would be known to a person of ordinary skill in the art, may be utilized for the purposes stated supra in conjunction with the particular computer system 90 of FIG. 4. For example, the memory devices 94 and 95 may be portions of a single memory device rather than separate memory devices.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

1. A method comprising:
receiving, by a mapping computing system comprising a computer processor, first data associated with a user;
linking, by said computer processor, social networking systems of said user to said computer processor;
periodically retrieving, by said computer processor from family and friend trees of said social networking systems, explicit social networking data associated with said user, wherein said explicit social networking data comprises explicitly stated location data of friends and relatives of said user;
periodically retrieving, by said computer processor from said social networking systems, implicit social networking data associated with said user, wherein said implicit social networking data comprises data generated based on message applied text analytics, social relationships, and associated strengths of said user;
first analyzing, by said computer processor, said explicit social networking data, said implicit social networking data, and said first data;
generating, by said computer processor, analysis data comprising results of said first analyzing;
receiving, by said computer processor, a request for planning a route of travel from a first location to a specified destination;
second analyzing, by said computer processor in response to said receiving said request, said analysis data with respect to said first location and said specified destination;
generating, by said computer processor in response to results of said second analyzing, a plurality of different travel routes from said first location to said specified destination, wherein each travel route of said plurality of different travel routes includes various stopping points associated with locations of individuals comprising relationships to said user, wherein said plurality of travel routes comprises a first mapped route, a second mapped route, and a third mapped route, wherein said first mapped route, said second mapped route, and said third mapped route each comprise differing routes of travel from said first location to said specified destination, wherein said first mapped route comprises a shortest primary travel route from said first location to said specified destination, wherein said second mapped route comprises a first travel route, from said first location to said specified destination, that includes a location of a friend of said user, and wherein said third mapped route comprises a second travel route, from said first location to said specified destination, that includes a location of a relative of said user;
generating, by said computer processor, graphical images associated with said individuals, wherein each graphical image of said graphical images comprises a differing graphical image based on a type of relationship of said relationships, wherein said graphical images comprises a first image representing said location of said friend and a second image representing said location of said relative, and wherein said first image differs from said second image; and
presenting simultaneously, by said computer processor to said user, graphical representations of said first mapped route, said second mapped route, and said third mapped route, said graphical representations comprising said first image and second image at associated stopping points of said friend and said relative.

2. The method of claim 1, wherein said individuals comprise friends or family members of said individual.

3. The method of claim 1, wherein said first data comprises data selected from the group consisting of demographic data, financial institution data, user identity data, data associated with Websites accessed by said user, and data associated with services requested by said user.

4. The method of claim 1, wherein said explicit social networking data associated with said user comprises data retrieved from social networks associated with said user, data retrieved form messaging applications associated with said user, and Website searches initiated from said user.

5. The method of claim 1, wherein said implicit social networking data associated with said user comprises data retrieved from social networks associated with said user, data retrieved form messaging applications associated with said user, and Website searches initiated from said user.

6. The method of claim 1, wherein said first analyzing comprises:
performing a user profile analysis with respect to said first data, said explicit social networking data, and said implicit social networking data;
performing an entity analysis with respect to said first data, said explicit social networking data, and said implicit social networking data;
performing an affinity analysis with respect to said first data, said explicit social networking data, and said implicit social networking data;
performing a relationship analysis with respect to said first data, said explicit social networking data, and said implicit social networking data; and
performing a sentiment analysis with respect to said first data, said explicit social networking data, and said implicit social networking data.

7. The method of claim 1, wherein said individuals comprise friends or family members of said individual, and wherein said graphical images comprise icons representing different types and levels of said friends or family members.

8. A process for supporting computing infrastructure, the process comprising providing at least one support service for at least one of creating, integrating, hosting, maintaining, and deploying computer-readable code in a computer comprising a processor, wherein the processor carries out instructions contained in the code causing the computer to perform the method of claim 1.

9. A computer program product, comprising a computer readable storage device storing a computer readable program code, said computer readable program code comprising an algorithm that when executed by a computer processor of a mapping computer system implements a method, said method comprising:
receiving, by said computer processor, first data associated with a user;
linking, by said computer processor, social networking systems of said user to said computer processor;
periodically retrieving, by said computer processor from family and friend trees of said social networking systems, explicit social networking data associated with said user, wherein said explicit social networking data comprises explicitly stated location data of friends and relatives of said user;
periodically retrieving, by said computer processor from said social networking systems, implicit social networking data associated with said user, wherein said implicit social networking data comprises data generated based on message applied text analytics, social relationships, and associated strengths of said user;
first analyzing, by said computer processor, said explicit social networking data, said implicit social networking data, and said first data;
generating, by said computer processor, analysis data comprising results of said first analyzing;
receiving, by said computer processor, a request for planning a route of travel from a first location to a specified destination;
second analyzing, by said computer processor in response to said receiving said request, said analysis data with respect to said first location and said specified destination;
generating, by said computer processor in response to results of said second analyzing, a plurality of different travel routes from said first location to said specified destination, wherein each travel route of said plurality of different travel routes includes various stopping points associated with locations of individuals comprising relationships to said user, wherein said plurality of travel routes comprises a first mapped route, a second mapped route, and a third mapped route, wherein said first mapped route, said second mapped route, and said third mapped route each comprise differing routes of travel from said first location to said specified destination, wherein said first mapped route comprises a shortest primary travel route from said first location to said specified destination, wherein said second mapped route comprises a first travel route, from said first location to said specified destination, that includes a location of a friend of said user, and wherein said third mapped route comprises a second travel route, from said first location to said specified destination, that includes a location of a relative of said user;
generating, by said computer processor, graphical images associated with said individuals, wherein each graphical image of said graphical images comprises a differing graphical image based on a type of relationship of said relationships, wherein said graphical images comprises a first image representing said location of said friend and a second image representing said location of said relative, and wherein said first image differs from said second image; and
presenting simultaneously, by said computer processor to said user, graphical representations of said first mapped route, said second mapped route, and said third mapped route, said graphical representations comprising said first image and second image at associated stopping points of said friend and said relative.

10. The computer program product of claim 9, wherein said individuals comprise friends or family members of said individual.

11. The computer program product of claim 9, wherein said first data comprises data selected from the group consisting of demographic data, financial institution data, user identity data, data associated with Websites accessed by said user, and data associated with services requested by said user.

12. The computer program product of claim 9, wherein said explicit social networking data associated with said user comprises data retrieved from social networks associated with said user, data retrieved form messaging applications associated with said user, and Website searches initiated from said user.

13. The computer program product of claim 9, wherein said implicit social networking data associated with said user comprises data retrieved from social networks associated with said user, data retrieved form messaging applications associated with said user, and Website searches initiated from said user.

14. The computer program product of claim 9, wherein said first analyzing comprises:
performing a user profile analysis with respect to said first data, said explicit social networking data, and said implicit social networking data;
performing an entity analysis with respect to said first data, said explicit social networking data, and said implicit social networking data;
performing an affinity analysis with respect to said first data, said explicit social networking data, and said implicit social networking data;
performing a relationship analysis with respect to said first data, said explicit social networking data, and said implicit social networking data; and
performing a sentiment analysis with respect to said first data, said explicit social networking data, and said implicit social networking data.

15. A computer system comprising a computer processor coupled to a computer-readable memory unit, said memory unit comprising instructions that when executed by the computer processor implements a method comprising:
receiving, by said computer processor, first data associated with a user;
linking, by said computer processor, social networking systems of said user to said computer processor;
periodically retrieving, by said computer processor from family and friend trees of said social networking systems, explicit social networking data associated with said user, wherein said explicit social networking data comprises explicitly stated location data of friends and relatives of said user;
periodically retrieving, by said computer processor from said social networking systems, implicit social networking data associated with said user, wherein said implicit social networking data comprises data generated based on message applied text analytics, social relationships, and associated strengths of said user;
first analyzing, by said computer processor, said explicit social networking data, said implicit social networking data, and said first data;
generating, by said computer processor, analysis data comprising results of said first analyzing;
receiving, by said computer processor, a request for planning a route of travel from a first location to a specified destination;
second analyzing, by said computer processor in response to said receiving said request, said analysis data with respect to said first location and said specified destination;
generating, by said computer processor in response to results of said second analyzing, a plurality of different travel routes from said first location to said specified destination, wherein each travel route of said plurality of different travel routes includes various stopping points associated with locations of individuals comprising relationships to said user, wherein said plurality of travel routes comprises a first mapped route, a second mapped route, and a third mapped route, wherein said first mapped route, said second mapped route, and said third mapped route each comprise differing routes of travel from said first location to said specified destination, wherein said first mapped route comprises a shortest primary travel route from said first location to said specified destination, wherein said second mapped route comprises a first travel route, from said first location to said specified destination, that includes a location of a friend of said user, and wherein said third mapped route comprises a second travel route, from said first location to said specified destination, that includes a location of a relative of said user;
generating, by said computer processor, graphical images associated with said individuals, wherein each graphical image of said graphical images comprises a differing graphical image based on a type of relationship of said relationships, wherein said graphical images comprises a first image representing said location of said friend and a second image representing said location of said relative, and wherein said first image differs from said second image; and
presenting simultaneously, by said computer processor to said user, graphical representations of said first mapped route, said second mapped route, and said third mapped route, said graphical representations comprising said image and second image at associated stopping points of said friend and said relative.

16. The computer system of claim 15, wherein said individuals comprise friends or family members of said individual.

17. The computer system of claim 15, wherein said first data comprises data selected from the group consisting of demographic data, financial institution data, user identity data, data associated with Websites accessed by said user, and data associated with services requested by said user.

18. The computer system of claim 15, wherein said explicit social networking data associated with said user comprises data retrieved from social networks associated with said user, data retrieved form messaging applications associated with said user, and Website searches initiated from said user.

19. The computer system of claim 15, wherein said implicit social networking data associated with said user comprises data retrieved from social networks associated with said user, data retrieved form messaging applications associated with said user, and Website searches initiated from said user.

20. The computer system of claim 15, wherein said first analyzing comprises:
performing a user profile analysis with respect to said first data, said explicit social networking data, and said implicit social networking data;
performing an entity analysis with respect to said first data, said explicit social networking data, and said implicit social networking data;
performing an affinity analysis with respect to said first data, said explicit social networking data, and said implicit social networking data;
performing a relationship analysis with respect to said first data, said explicit social networking data, and said implicit social networking data; and
performing a sentiment analysis with respect to said first data, said explicit social networking data, and said implicit social networking data.
